(19) United States
(12) Patent Application Publication
(10) Pub. No.: US 2003/0118245 A1
(43) Pub. Date: Jun. 26, 2003

(54) Automatic focusing of an imaging system

(76) Inventors: Leonid Yaroslavsky, Kfar Saba (IL); Daniel A. Usikov, Newark, CA (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/027,462

(22) Filed: Dec. 21, 2001

(51) Int. Cl. G06T 5/00; G06K 9/20; G06T 7/00; H04N 5/232; G06K 9/62; G06K 9/46

(52) U.S. Cl. 382/255; 348/345; 348/349; 348/353; 382/199; 382/218

(57) ABSTRACT

A method of automatically focusing an imaging system and an imaging system having automatic focusing use an image of an object created by the imaging system to determine an optimum focus position. The present invention employs one or both of an edge detection approach and an image comparison approach to automatic focusing. The edge detection approach comprises computing an edge density for each image of a set of images of the object, and using a focus position corresponding to an image of the set that has a greatest computed edge density as the optimum focus position. The image comparison approach comprises adjusting a focus position for the image of the object by a difference between focus positions for a reference image and a closely matched image of a typical object. The imaging system has a computer program comprising instructions that implement the method of the invention.

### TECHNICAL FIELD

The invention relates to imaging systems. In particular, the invention relates to imaging systems used as inspection systems.

### BACKGROUND ART

Imaging systems are used in a wide variety of important and often critical applications, including but not limited to, identification and inspection of objects of manufacture. In general, imaging systems either employ ambient illumination or provide an illumination source to illuminate an object being imaged. In the most familiar imaging systems, the illumination source is based on some form of electromagnetic radiation, such as microwave, infrared, visible light, Ultraviolet light, or X-ray. Aside from the various forms of electromagnetic radiation, the other most commonly employed illumination source found in modem imaging systems is one that is based on acoustic vibrations, such as is found in ultrasound imaging systems and Sonar systems.

For example, an imaging system used for object inspection that uses X-ray illumination is X-ray laminography. X-ray laminography is an imaging technique that facilitates the inspection of features at various depths within an object. Usually, an X-ray laminography imaging system combines multiple images taken of the object to produce a single image. The multiple images are often produced by moving an X-ray point source around the object and taking or recording the images using different point source locations. By taking images when the source is at various locations during the movement of the source, the combined image is able to depict characteristics of the internal structure of the object. In some instances, such as in analog laminography, the images are combined directly during the process of taking the images. In digital X-ray laminography, often called tomosynthesis, individual images are combined digitally to produce a combined image. An important application of X-ray laminography is the inspection of multilayer printed circuit boards (PCBs) and integrated circuits (ICs) used in electronic devices.

The X-ray laminography imaging system, like other imaging systems and image-based inspection systems, must be focused to produce accurate images for the object being inspected. That is, there is an optimum location of the object being imaged in X-ray laminography that produces a best or clearest image of the object. For example, in an X-ray laminography PCB inspection system, there is an optimum location of a PCB surface being inspected relative to the X-ray source that produces a clearest image of the surface of the PCB. In such a system, focusing typically involves changing a vertical or z-location of the PCB until the optimum location is obtained and the image is focused. In other imaging systems, elements of a lens system may be adjusted to move a point of focus such that it is coincident with the optimum z-location. In addition to merely requiring focusing to produce clear images, many imaging systems are highly sensitive to image focusing. That is, small errors in focusing can have significant effects on the quality of the image and the ultimate results of an inspection. For example, in X-ray laminography PCB inspection, a small variation or error in focusing (i.e., z-location of a PCB lying in an xy plane) can result in an image being formed of a back surface of a PCB instead of a front surface of the PCB.

Many imaging and related image-based inspection systems employ some form of automatic focusing to insure that proper focusing is achieved prior to recording an image. For example, X-ray laminography PCB inspection systems conventionally employ a laser rangefinder. The laser illuminates a target located on the PCB and a z-axis position or z-location of the target is determined. The determined z-location then is used to set the focus of the laminography system usually by adjusting the z-location of the PCB to coincide with a plane of focus of the laminographic inspection system. If the PCB is large, several targets may be used at different xy-locations on the board to account for possible warpage of the PCB.

The use of the laser rangefinder has a number of drawbacks, not the least of which is that such a focusing method can be very slow. In fact, focusing using the laser rangefinder in X-ray laminography often accounts for a substantial portion of the time it takes to produces a single image of a PCB. In addition, the use of targets on the PCB in conjunction with focusing means that a precise location (e.g., xy target location) of the targets must be established for a given PCB before automatic focusing can be attempted. Furthermore, since the targets are located at a finite number of discrete points on the PCB surface, warpage of the board can still present a problem for focusing, especially in images of regions of interest that are relatively far removed from the target locations.

Accordingly, it would be advantageous to have a focusing method and apparatus for imaging systems that eliminate the need for laser rangefinders and the use of discrete targets. In addition, it would be desirable if the method and apparatus can provide accurate focusing even in the presence of substrate warpage. Such a method and apparatus would solve a long-standing need in the area of imaging systems, especially those used for inspection.

### SUMMARY OF THE INVENTION

According to embodiments of the present invention, a method of automatically focusing an imaging system and an imaging system having automatic focusing are provided. In particular, the present invention provides automatic focusing by using an edge detection approach and/or an image comparison approach to automatically focus the imaging system. An optimum focus position is determined using an image or images created by the system. Moreover, the determination is made without the need for or use of a specialized range finding apparatus, such as a laser rangefinder.

In some embodiments of the method of the present invention, an image-based edge-density approach is employed to determine an optimum focus position of the imaging system for creating a focused image of an object. In other embodiments, the optimum focus position is determined using a rapid and efficient image comparison approach that compares an image of an object being imaged to a set of images of a typical object. A change in focus indicated by the comparison leads to a determination of an optimum focus position for the system.

The present invention is particularly suited to focusing of imaging systems that are used to image objects, such as printed circuit boards (PCBs). Images of objects such as PCBs typically have a large number of distinct linear image primitives (e.g., edges) in a focused image. Thus, the automatic focusing according to the present invention is particularly applicable to image-based inspection systems, such as X-ray laminography PCB inspection systems.

In one aspect of the invention, a method of determining an optimum focus position for an imaging system using images of an object created by the imaging system is provided. When set to the optimum focus position, the system produces a focused image of the object. The method comprises creating a set of images of the object at a plurality of different focus settings or positions. In particular, each image in the set is created at a different one of the plurality of focus positions. The method of focusing further comprises computing a density of edges observed or detected in each image of the set. The edge density is computed using any one of several edge-detection methods known in the art, including but not limited to, a gradient method. The method of focusing further comprises determining an optimum focus position. In some embodiments, the optimum focus position is a focus position corresponding to the image of the set having a greatest computed edge density.

In another aspect of the invention, a method of determining a change in focus position of an imaging system using images created by the system is provided. In the method of determining a change in focus position, an image of an object being imaged is compared to a set of images of a typical object. The change in focus position thus determined is then used to achieve an optimum focus position of the system enabling the creation of a focused image of the object being imaged. The method of determining a change in focus position comprises creating a set of images of a typical object with the imaging system. Each image of the set corresponds to and is identified with a different one of a plurality of focus positions of the imaging system. The method further comprises selecting from the set of images an image that represents an optimum focus position. The image having an optimum focus position thus selected is called a reference image. The method further comprises creating an image of an object being imaged using the imaging system at an arbitrary focus position. The method further comprises comparing the image of the object being imaged to the set of images of the typical object to find a closest matching image within the set. The method further comprises determining a change in focus position from the arbitrary position used to create the image of the object being imaged to the optimum focus position for imaging the object. The change in focus position is determined from the results of comparing and of selecting.

In yet another aspect of the invention, an imaging system having automatic focusing is provided. In some embodiments, the imaging system is part of an inspection system. The imaging system employs the method of automatic focusing according to the present invention, namely one or both of an edge detection approach or an image comparison approach to automatic focusing. Preferably, the imaging system of the present invention employs one or both of the method of determining an optimum focus position and the method of determining a change in focus position of the present invention. In particular, the imaging system comprises an imaging subsystem, a controller/processor, a memory, and a computer program stored in the memory and executed by the controller processor. The computer program comprises instructions that, when executed by the controller/processor, implement the automatic focusing according to the present invention.

As mentioned hereinabove, the present invention provides automatic focusing without the use of a dedicated, special-purpose rangefinder. The present invention employs image processing of images to determine a range of focus positions, and from the range, to determine an optimum focus setting or position. The automatic focusing of the present invention can be very rapid, limited only by the speed of the edge-detection and/or image comparison used therein. In addition, elimination of a dedicated rangefinder or other specialized optics according to the present invention can reduce the cost of the imaging system, thereby rendering the imaging system of the present invention more economical. Moreover, elimination of a dedicated automatic focusing apparatus or subsystem, such as a laser rangefinder, can improve the reliability of imaging systems according to the present invention. The present invention is particularly useful in inspection systems, including but not limited to, PCB inspection systems. Certain embodiments of the present invention have other advantages in addition to and in lieu of the advantages described hereinabove. These and other features and advantages of the invention are detailed below with reference to the following drawings.

### BRIEF DESCRIPTION OF THE DRAWINGS

The various features and advantages of the present invention may be more readily understood with reference to the following detailed description taken in conjunction with the accompanying drawings, where like reference numerals designate like structural elements, and in which:

FIG. 1 illustrates a flow chart of a method of determining an optimum focus position of an imaging system according to the present invention.

FIG. 2 illustrates a graph of computed edge density versus focus position according to the method of FIG. 1.

FIG. 3 illustrates a flow chart of a method of determining a change in focus position of an imaging system according to the present invention.

FIG. 4 illustrates geometric model of an X-ray laminography embodiment of an imaging system of the present invention imaging a planar object.

FIG. 5 illustrates a block diagram of an imaging system having automatic focusing according to the present invention.

### MODES FOR CARRYING OUT THE INVENTION

The present invention automatically focuses an imaging system and provides an imaging system having automatic focusing. The present invention uses image processing applied to an image or images created by the imaging system to determine an optimum focus setting or position for the imaging system. Thus, the present invention eliminates the need for and the use of a separate or integral, specialized automatic focusing apparatus or subsystem, such as a laser rangefinder, as is used in conventional imaging systems having automatic focusing. The automatic focusing of the present invention is applicable to a wide variety of imaging systems, especially those that image objects with feature-rich surfaces, such as printed circuit boards (PCBs) and integrated circuits (ICs). Moreover, since the present invention does not employ specialized hardware to accomplish automatic focusing, advantageously the present invention can be implemented as a software or firmware upgrade to an existing imaging system.

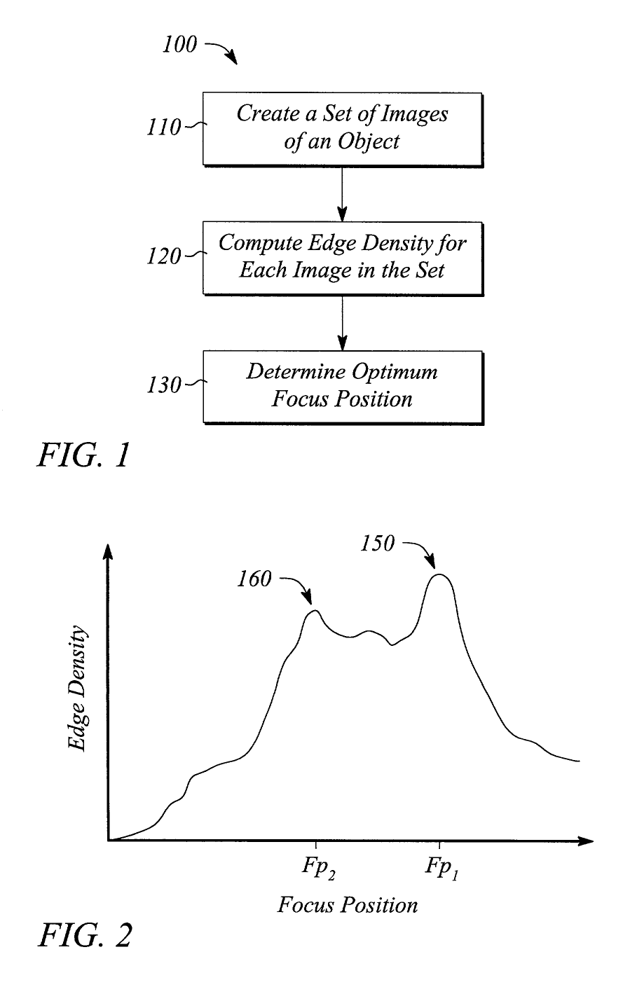

FIG. 1 illustrates a flow chart of a method 100 of determining an optimum focus position of an imaging system using images of an object created by the imaging system according to the present invention. The method 100 of determining an optimum focus position comprises creating 110 a set of images of an object using the imaging system. Each image of the set of images is an image of a region of interest of the object. The region of interest may encompass any portion of the object up to and including the entire object and even some of an area surrounding the object. Normally however, the region of interest is a small portion of the object. For example, the region of interest may be a relatively small rectangular portion of a much larger object. In such a case, the images created are likewise images of the small rectangular portion of the object.

In some imaging systems, images are created that represent roughly planar slices through an interior portion of an object being imaged. An example of such an imaging system is an X-ray laminography system. With such systems, the region of interest may also include a specified depth within the object at which the image is taken. Thus in general, the region of interest includes a planar extent as well as a depth component.

Each image of the set is created 1 10 at a different one of a plurality of different focus settings or positions of the imaging system. A definition of a focus position is unique to a given type of imaging system. For example, a focus position for an X-ray laminography system is a position of the object relative to an X-ray source and/or detector of the system. In an optical imaging system, such as a camera, the focus position is a location of one or more lenses in optics employed by the system relative to other lenses and/or to a focal plane or image plane of the system.

As used herein, the term ‘optimum focus position’ refers to a focus position of the system that produces a best or most nearly perfectly ‘focused’ image of the region of interest of the object being imaged. For example, in the case of an optical camera the optimum focus position is a focus position that produces a clear, sharply defined image of the object being imaged. The image created by the imaging system at an optimal focus position is said to be ‘in focus’. In an X-ray laminography system, each image produced is essentially focused with respect to a focal plane of the system. However, the region of interest of the object (e.g., a top surface of a PCB) may or may not be located in the focal plane. Thus, for imaging systems that use focal plane focusing such as, but not limited to, an X-ray laminography system, the optimum focus position is the focus position that places the region of interest of the object in the focal plane of the system. In such systems, the term ‘in focus’ with respect to images of an object being imaged means that the region of interest of the object is located in the focal plane of the system. One of ordinary skill in the art can readily extend the notion of optimum focus to other imaging systems without undue experimentation.

Preferably, a range of focus positions represented by the plurality of focus positions spans or includes the optimum focus position. For example, if the focus positions represent a location of an object along a vertical or z-axis, an upper limit of the range is preferably chosen such that the upper limit is likely to be above an optimum focus position of the imaging system. Likewise, a lower limit of the range is preferably chosen such that the lower limit is likely to be below an optimum focus position. Thus, the range of focus positions in the preceding example spans the optimum focus position of the imaging system.

In a preferred embodiment, the set of images thus created 110 are converted to a digital format comprising an array of pixels that form the images. Analog images, such as those produced by imaging systems that employ photographic film or analog electronic imaging encoding, can also be used by the method 100, although direct conversion to and use of a digital image format greatly simplifies the implementation of the method 100 as well as enhances its practicality. Preferably, the images, either analog or digital, once created 110 are stored for later use. For example, a set of digital images may be stored in a computer memory. In other embodiments, the images may be processed, according to the method 100, as a group or on an individual basis and then discarded, as further described hereinbelow.

The method 100 of determining an optimum focus position further comprises computing 120 a density of edges observed in each image of the set. The edge density is preferably computed 120 for each image of the set using an edge-density metric, or measure of edge density. The edge-density metric, in turn, preferably employs one of several well-known edge-detection or related image-processing methods known in the art, including but not limited to, one of several gradient methods. Computing 120 an edge density ultimately produces a numerical value that is related to the number of edges in the image.

In general, an edge in an image is linked to or associated with a feature of the object being imaged. Typically, edges are most closely associated with features having a linear extent or boundary although curvilinear features may also produce edges in an image. For example, in an image of a PCB, metal traces, solder joints and components attached to the PCB are all features that will all produce observed edges in the image. Since edge density is related to linear and/or curvilinear features, the more features in a region of interest on the object encompassed by an image, the higher the computed 120 edge density.

From the standpoint of the image itself, an edge is typically characterized by a relatively abrupt change in brightness and/or color. For example, in a purely black and white digital image, an edge is often identified as a white pixel having at least one neighboring black pixel or a black pixel having at least one adjacent white pixel. In a digital, gray-scale image, an abrupt change in gray-scale from one pixel to an adjacent pixel usually is taken to constitute an edge. Thus, as is familiar to one of ordinary skill in the art, many edge detection methods involve some form of gradient measure that compares adjacent points or pixels in an image with one another. In simple terms, if a gradient or change in image brightness encoded in pixels (e.g., ‘black and white’ or gray-scale) of an image is computed for each pixel with respect to its neighboring pixels, then those pixels exhibiting large gradients are likely to represent edges in the image.

More generally, gradient-based, edge detection methods known in the art of digital image processing are often referred to as gradient operators and/or compass operators. The term ‘operator’ refers to the standard practice of using matrix mathematics to process the digital image as represented by an array of pixels. Commonly employed gradient operators include, but are not limited to, the Roberts, Smoothed or Prewitt, Sobel, and Isotropic operators. Gradient-based edge detection may also employ a Laplace operator or a zero-crossing operator, as well as techniques that employ stochastic gradients. Stochastic gradient operators are especially attractive as edge-detectors when dealing with noisy images. Other edge-detection method, such as those that employ a Haar transform may also be used to detect edges in an image as part of computing 120 the edge density.

One skilled in the art of digital image processing is familiar with these and other edge-detection methods all of which are within the scope of the present invention. In fact, an absolute accuracy or sensitivity of the edge-detection method is not of great importance to the method 100. Thus, virtually any edge-detection method may be employed in computing 120 the edge density.

While the use of a specific edge-detection method is not required by the present invention, some edge-detection methods perform more reliably than others, especially in the presence of noise in the images. One of ordinary skill in the art can readily select from among known edge-detection methods for use in a given application of the method 100 without undue experimentation.

Similarly, an absolute accuracy of the computed 120 edge density is not particularly important according to the present invention. In particular, the method 100 utilizes a computed 120 edge density of a given image relative to computed 120 edge densities of other images in the set. Therefore, any edge-detection image-processing method that ultimately produces a relatively consistent measure of edge density or edge-density metric may be used in computing 120. A ‘consistent’ edge-density metric is one that produces a different edge density value for two images having a different number of distinct or detected edges. Moreover, the consistent metric produces an edge density value that is related to the number of edges in an image.

For example, consider a pair of images wherein a first image of the pair has more edges than a second image of the pair. One such consistent metric always assigns a higher edge density value to the image having more edges and a lower edge density value to the image having fewer edges. Thus, a useful edge density metric for computing 120 is a proportional metric that computes 120 edge density directly from a number of detected edges in an image. For this metric, once the number of edges, or equivalently, the number of pixels containing edges is determined using edge-detection, edge density may be computed by dividing the number of edges (e.g., pixels containing edges) by a total number of pixels in the image. One skilled in the art can readily devise a number of other suitable edge-density metrics for computing 120 the edge density. All such edge-density metrics are within the scope of the present invention.

In addition, it is often useful, although not required, to apply a filter or other smoothing approach to the image prior to calculating the gradients or employing the gradient operator to improve the performance of a gradient-based edge detection method employed in computing 120 the edge density. Filtering tends to smooth data represented by the image pixels, thereby often improving gradient-based edge detection. One such smoothing filter is a sliding window filter (e.g., an 11×11 pixel sliding window) that has proven to be effective. In addition to improving the performance of the gradient-based edge detection methods in the presence of image noise, smoothing of the image prior to applying the gradient-based edge detection method may improve an ability to distinguish between a surface of an object and various buried feature layers within the object. For example, smoothing an X-ray image of a multilayer PCB generally improves the ability to distinguish between a surface of the PCB containing solder joints and various buried intermediate circuitry layers within the multilayer PCB.

The method 100 of determining an optimum focus position further comprises determining 130 the optimum focus position or setting. In general for most objects, the optimum focus position produces a focused image of the object and is the focus position corresponding to the image having a greatest number of edges or a greatest edge density. Advantageously, out-of-focus images tend to exhibit blurring or an overall reduction in the sharpness of edges in the image while focused images exhibit sharp edges. The effect of blurring in an out-of-focus image can be thought of as a spatial averaging of the pixels. Edge-detection methods, especially those employing gradients, are less likely to detect blurred edges caused by this spatial averaging. Therefore, the spatial averaging of out-of-focus images results in fewer detected edges. Furthermore, if a proportional metric is used, the determined 130 optimum focus position typically corresponds to the image of the set of images having the highest computed 120 edge-density value.

For example, if the images of the set are of a surface of a PCB, the image having the highest computed 120 edge density using the proportional metric corresponds to an optimum focus position. Thus, the optimum focus setting or position for imaging the PCB surface is found by determining 130 the focus position from an image having a maximum computed 120 edge density (e.g., z-location of the PCB having the greatest edge-density). FIG. 2 illustrates a graph of computed 120 edge density versus focus position for an example set of images of a PCB. For the example, the images are created using an X-ray laminography PCB inspection system. A first peak value 150 of edge density corresponds to a top surface of the PCB, while a second peak value 160 of edge density corresponds to a bottom surface. The optimum focus position for imaging the top surface of the PCB is the focus position Fp₁ corresponding to the first peak 150 while the optimum focus position for imaging the bottom surface is a focus position Fp₂. In the example, an 11×11 pixel smoothing filter was applied to the images prior to computing gradients to detect edges in computing 120 the edge density.

Note that in the example illustrated in FIG. 2, no a priori information regarding the actual thickness of the PCB is required to determine the optimum focus position according to method 100 of the present invention. Likewise, the optimum focus position is determined 130 entirely from the image itself without the assistance or use of a separate automatic focusing module, such as a laser rangefinder. As noted hereinabove, data smoothing may be used to assisting in determining an optimum focus position. Likewise, interpolation between focus positions of images may be used to better determine 130 an optimum focus position from the set of images.

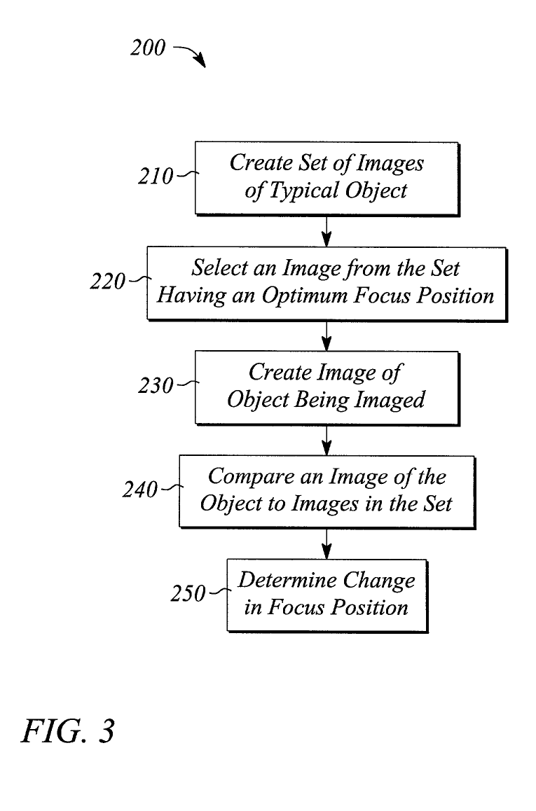

In another aspect of the invention, a method 200 of determining a change in focus setting or position of an imaging system to create a focused image of an object being imaged or under inspection is provided. FIG. 3 illustrates a flow chart of the method 200 of determining a change in focus position of an imaging system. The method 200 of determining a change in focus position comprises creating 210 a set of images of a typical object with the imaging system. Each image of the set corresponds to and is identified with a different one of a plurality of focus positions of the imaging system. Creating 210 a set of images is essentially the same as creating 110 a set of images of the method 100 except that each image of the set of images is an image of a region of interest of a so-called ‘typical object’. The term ‘typical object’, as used herein, is an object that is representative of a class of objects. The class of objects includes a plurality of objects imaged by the imaging system. For example, a typical object might be a particular PCB selected from a set of PCBs (i.e., the class) being inspected by an image-based inspection system. The set of images thus created 210 are stored for later use in the method 200. Preferably, the images are converted to and stored in a digital format wherein each image consists of an array of pixels.

The method 200 further comprises selecting 220 from the set of images an image called a reference image that represents an optimum focus position. The selected 220 reference image is generally the image that is most nearly ‘in focus’ with respect to the region of interest of the object being imaged. The focus position associated with the selected 220 reference image is then the optimum or ‘reference’ focus position. Selecting 220 a reference image may be accomplished manually or automatically. The set of images may be viewed by an operator. The operator manually selects 220 a best or most focused image from the set to be the reference image for the region of interest. Alternatively, an automatic method of selecting an optimally focused reference image may be employed.

Preferably, the reference image is selected 220 automatically and comprises a variation of method 100 of the present invention. Namely, after the set of images of the typical object is created 210, the edge densities are computed 120 for each of the images of the set and an optimum focus position is determined 130 according to the method 100. The image corresponding to the determined 130 optimum focus position is then selected 220 as the reference image for the region of interest and the determined optimum focus position is the reference focus position for the reference image.

For example, a PCB has two major surfaces and multiple layers between the major surfaces that each may be a region of interest for imaging. An X-ray laminography system may be used to image any and all of the surfaces and layers of the PCB. Therefore in selecting 220 the reference image, the surface or layer of interest is a consideration when choosing among images of the set having the determined 130 optimum focus position. Thus for example, to focus on a front major surface of a PCB, the image of the set having the determined 130 optimum focus position (i.e., highest computed edge density) corresponding to the front major surface of the PCB is then selected 220 as the reference image. Alternatively, to focus on a back major surface of the PCB, the image of the set having a second highest edge density is selected 220 as the reference image.

The method 200 further comprises creating 230 an image of an object being imaged or under inspection with the imaging system at an arbitrary focus position. The object being imaged is an object similar to or in the same class as the typical object. For example, the object being imaged might be a particular one of the set of PCBs to be inspected. Moreover, the image created 230 of the object being imaged encompasses a same region of interest of the object being imaged as the region of interest of the typical object encompassed by the images of the set of images. The region of interest is described hereinabove with respect to method 100. For example, the region of interest might be a small portion of the object, such as a small portion of a surface of a PCB where a solder joint is located or a small portion of a buried wiring layer inside of the PCB.

The method 200 further comprises comparing 240 the image of the object being imaged to images in the set of images of the typical object to find a closest matching image within the set. Preferably, the image of the object being imaged is compared 240 to a subset of the images in the set. The subset is selected in a manner that attempts to insure that the closest matching image in the set as a whole is likely to be contained in the subset. For example, if a priori information regarding a most likely location of the closest matching image within the set is available, the information may be employed to direct the comparison 240 to a particular subset of the images in the vicinity of the most likely location. One skilled in the art can readily devise several useful subset-based search methodologies in addition to one employing a priori information that may reduce the time required to locate the closest matching image. All such subset-based search methodologies are within the scope of the present invention.

The comparison 240 may be conducted using any norm or standard including, but not limited to, a sum of an absolute value of a difference between pixels, a sum of a square of the difference between pixels, and a cross correlation. Essentially, any correlation algorithm that allows a relative comparison of a pair of images to be performed may be used in comparing 240. In essence, the correlation algorithm computes a correlation value (i.e. degree of sameness) between the image of the object being imaged and each of the images in the set of images of the typical object. The correlation value is proportional to the ‘sameness’ of the images. The image in the set of images that has the highest correlation with that of the image of the object being imaged is considered to be the closest matching image. Correlation of images is well known in the art of comparing images. Other methods of comparing images are known in the art and familiar to one of ordinary skill. Any such methods may be employed in comparing 240 and all such methods of image comparison are within the scope of the present invention.

As with gradient computation, filtering of the images prior to computing a correlation value may be used to improve the performance of the correlation algorithm. The filtering, in particular equalization filtering, may help to remove so-called ‘slow space frequency’ brightness variations in the images due to intrinsic errors and variations in the imaging system unrelated to the object being imaged. Examples of useful filtering approaches include, but are not limited to, a sliding window equalization, a normalization, and a high pass filter. In particular, both a 15×15 pixel and a 21×21 pixel sliding window used in a sliding window equalization filter algorithm have proven helpful in preprocessing images from an X-ray laminography PCB inspection system, for example, prior to computing a correlation between images according to the comparison 240. The exemplary inspection system created 1024×1024 pixel images.

The method 200 of determining a change in focus position further comprises determining 250 the change in focus position such that an optimally focused image of the object being imaged is created. The change in focus position is determined 250 from the closest matching image of the comparison 240 and the selected 220 reference image representing the optimum or reference focus position of the system. Once the change in focus position is determined 250, the imaging system is focused and a focused image of the object being imaged is created.

In particular, as was discussed hereinabove with regard to creating 210 the set of images, each image in the set is identified with a focus position at which the image was created 210. Thus, the focus position identified with the closest matching image in the set from the comparison 240 establishes a comparison focus position of the system. Determining 250 the change comprises determining a difference between the comparison focus position and the optimum or reference focus position associated with the selected 220 reference image, and applying the difference in focus position to the arbitrary or current focus position used in creating 230 the image of the object being imaged. The determined 250 change results in the imaging system providing an optimally focused image of the object being imaged. In other words, the change in focus position from the current focus position to one that will produce an optimally focused image of the object being imaged is determined 250 by applying the difference between the comparison focus position of the matching image 240 and the optimum or reference focus position of the selected 220 reference image to the current focus position. The difference plus the current focus position becomes the optimum focus position for imaging the object being imaged.

By way of example, consider an X-ray laminography system 300 used to image essentially planar objects, such as PCBs or ICs. The example of an X-ray laminography system 300 is considered for illustrative purposes only and in no way limits the scope of the present invention. In particular, the present invention applies equally well to other imaging systems including, but not limited to, optical imaging systems, tomosynthesis systems, and tomography systems.

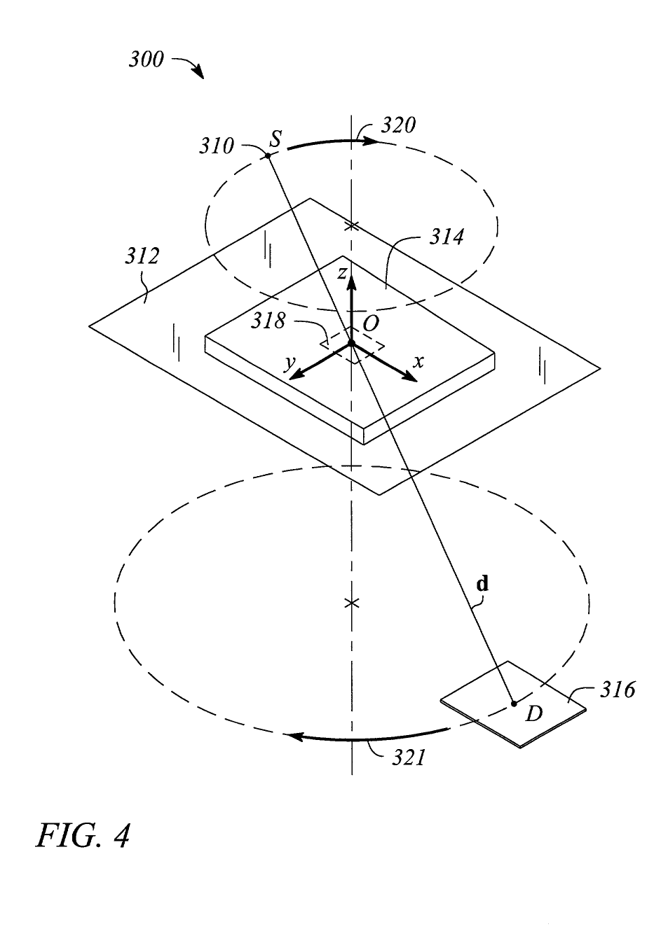

FIG. 4 illustrates a geometric model of a typical X-ray laminography system 300. The system comprises an X-ray illumination source 310 located above a planar surface called the focal plane 312, and a detector 316 positioned below the focal plane 312. A 3-dimensional object 314 being imaged is located between the illumination source 310 and the detector 316. The portion of the object 314 lying in the focal plane 312 will be the portion in focus and thus imaged when an image is created by the system 300.

For purposes of the discussion hereinbelow, assume that a Cartesian coordinate system is used to define the relative locations and orientations of the X-ray source 310, focal plane 312, the object 314, and the detector 316. The Cartesian coordinate system is illustrated in FIG. 4 as three arrows labeled x, y, and z corresponding to an x-axis, a y-axis and a z-axis of the coordinate system, respectively. Furthermore, assume that the focal plane 312 is located and oriented such that the focal plane 312 lies in an x-y plane of the Cartesian coordinate system, the x-y plane having a defining coordinate z₀. Furthermore, let a center point or origin O of the focal plane 312 be defined by the coordinates (0, 0, z₀). The region of interest 318 of the object 314 similarly lies in an x-y plane having a defining coordinate Z_{obj}. A focused image of the region of interest 318 is created by the system 300 if an only if the region of interest 318 is approximately located at coordinates (0, 0, Z_{obj}=z₀).

As illustrated in FIG. 4, the X-ray source 310 is located above the focal plane 312 at a point S given by the coordinates S=(xₛ, yₛ, zₛ), where the value of the z-axis coordinate zₛ is greater than the z-axis coordinate z₀. Likewise, the detector 316 is located below the focal plane 312 having a center point located at a point D given by the coordinates D=(X_{d}, Y_{d}, Z_{d}), where the value of the z-axis coordinate z_{d} is less than the z-axis coordinate z₀. A vector d defines a central ray of illumination from the source 310 to the detector 316 that passes through the origin O. One skilled in the art would readily recognize that the choice of the Cartesian coordinate system, the choice of the x-y plane and z₀ are totally arbitrary and that the choice merely facilitates discussion herein.

An image or picture of the region of interest 318 of the object 314 is created by the imaging system by locating the region of interest 318 in the focal plane 312 and approximately centered on the origin O. The source 310 and the detector 316 are then rotated about a z-axis passing through the origin O as indicated by arrows 320, 321. Thus, the source 310 and detector 316, as denoted by the points S and D, move in a circular path within their respective x-y planes during imaging. At each of a plurality of rotation angles, an intensity or magnitude of the illuminating radiation (e.g., X-ray) that passes through the object 314 is measured using the detector 316. Typically, the detector 316 comprises an array of detectors so that at each rotation angle, a large number of simultaneous intensity measurements are made. The individual measurements at each rotation angle are summed to create the final image. Thus, the image consists of a large number of summed intensity measurements taken and recorded at a large number of points for a region of interest 318 on the object 314.

The summed measurements that make up the image often are associated with small rectilinear regions or quasi-rectilinear regions of the object 314 and the region of interest 318 is a larger rectangular region. The corresponding small regions of the image formed from the individual measurements are referred to as pixels, while the sum of the pixels is referred to as the image. Therefore, the image can be said to consist of a matrix or grid of pixels, each one of the pixels recording the brightness or intensity of the interaction between the object 314 and the illumination.

When an image or picture is created of the object 314 illuminated by the source 310, the brightness recorded in the image will be a function of the characteristics of the object 314 (i.e., reflectivity and/or transmissivity). A focus position Fp (not illustrated) of the imaging system 300 is given by the z-axis coordinate z₀ of the focal plane 312 during the creation of the image. Thus for example, each image created 110, 210 by the example system 300 can be identified by the focus position Fp that equals a particular value of the z-axis coordinate z₀.

Assume that the set of images are created 110, 210 and that the set includes one hundred images, for example. Thus, there are one hundred distinct focus positions Fpᵢ (i=1, . . . , 100) represented by the set of images. Furthermore, assume that a 4-th image of the set having a focus position Fp₄ is selected 220 as the reference image with the optimum or reference focus position for the typical object. The image of the object 314 being imaged is then created 230 at an arbitrary focus position Fpₓ. Once created 230, the image of the object 314 being imaged is cross-correlated with images of the set in the comparison 240. Preferably, a subset smaller than the set is employed in the comparison 240. A maximum cross correlation C_{i,max} identifies the closest matching image in the set to the image of the object being imaged. For example, assume that the 54-th image produced the maximum cross correlation (i.e., C₅₄>Cᵢ, ∀i≠54). Then, the difference between the focus position Fp₅₄ and the focus position Fp₄ determines 250 the change in focus position ΔFp needed to obtain a focused image of the object being imaged. Thus, an optimally focused image of the object being imaged is created by adjusting the focus position of the system by an amount equal to the determined 250 change in focus position ΔFp.

Among other things, the methods 100 and 200 of the present invention automatically account for or accommodate warpage of the object. Such warpage or deviation from an ideally flat configuration is common in many objects such as PCBs being imaged. In particular, the determination 130 of the optimum focus position of the method 100 is not dependent on assuming that the object is completely flat. In fact, the method 100 explicitly adjusts the focus position of the imaging system to an optimum focus position that advantageously accommodates for warpage of the object.

The method 200 can likewise accommodate object warpage. More importantly, the method 200 does not depend on a perfectly flat or non-warped typical object. If the typical object is warped, the method 200 can mathematically remove the warpage from the focus positions of the set of images advantageously to ‘reposition’ the optimum focus position at an arbitrarily determined point.

In particular, if the typical object is warped, the optimum focus position of the selected 220 image may not correspond to a known or predetermined zero or reference focus position that represents an optimum focus position for imaging a perfectly flat or unwarped object. In such a case, a value corresponding to the typical object optimum focus position can be subtracted from focus position values for each of the images of the set. This effectively shifts the apparent focus positions of the images of the set by an amount corresponding to the warp of the typical object. Then, when method 200 is used to focus the system for imaging an object being imaged, the shifted values for the focus positions result in a determined 250 change that is unaffected by the warp in the typical object.

In yet another aspect of the invention, an imaging system 400 that employs automatic focusing is provided. In some embodiments, the imaging system is part of an inspection system. The imaging system 400 of the present invention employs the method of automatic focusing of the present invention, namely one or both of edge detection-based and image comparison-based automatic focusing.

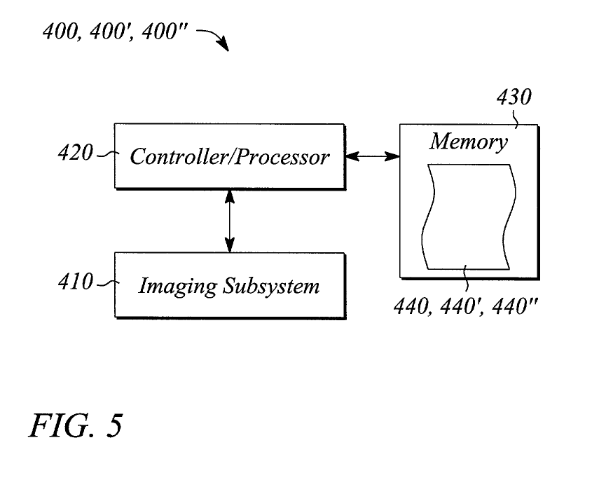

FIG. 5 illustrates a block diagram of the imaging system 400 of the present invention. The imaging system 400 comprises an imaging subsystem 410, a controller/processor 420, a memory 430, and a computer program 440 stored in memory 430. The controller/processor 420 executes the computer program 440 and controls the focusing of the image subsystem 410. The computer program 440 comprises instructions that, when executed by the controller/processor, implement automatic focusing according to the present invention.

In particular, in preferred embodiments of the system 400, the computer program 440 comprises instructions that implement one or both of the methods 100 and 200. In some embodiments of the system 400′, the computer program 440′ comprises instructions that implement an edge density approach to automatic focusing. The instructions implement creating a set of images of an object at a plurality of different focus settings or positions, computing a density of edges observed in each image of the set, and determining an optimum focus position from the computed edge density. In particular, the determined optimum focus position may be a focus position associated with an image of the set having a greatest edge density. The computer program 440′ may also contain instructions by which the controller/processor 420 can affect a focus adjustment of the imaging subsystem 410 using the determined optimum focus position.

In other embodiments of the system 400″, the computer program 440″ comprises instructions that implement an image comparison approach to automatic focusing. Moreover, in some of these other embodiments, the image comparison approach further comprises using the edge density approach. The instructions implement creating a set of images of a typical object, each image of the set corresponds to and is identified with a different one of a plurality of focus positions of the imaging system. Once created, the set of images preferably is stored in the memory 430. The computer program 440″ further implements selecting an image having an optimum focus position from the set of images. As mentioned above, it is in this selection that the edge density approach may be used. The computer program 440″ further implements creating an image of an object being imaged at an arbitrary focus position, comparing the image of the object being imaged to the set of images of the typical object to find a closest matching image within the set, and determining a change in focus position from a focus position identified with the closest matching image in the set and the selected image. The change is applied to the arbitrary focus position to focus the imaging system.

Advantageously, the present invention may be implemented as a set of instructions of a computer program stored in a memory of an existing imaging system. Thus, the automatic focusing of the present invention may be incorporated in an existing imaging system as a software or firmware upgrade. In other embodiments, the automatic focusing of the present invention may be added to an existing system using an external computer as a controller/processor. The external computer executes the computer program 440, 440′, 440″ stored in memory of the computer. By executing the computer program 440, 440′, 440″, the external computer provides image processing of images produced by the imaging system and affects control of focus position of the imaging system to achieve the optimum focus position according to the present invention.

Thus, there has been described novel methods 100, 200 of automatic focusing and an imaging system 400, 400′, 400″ having automatic focusing. It should be understood that the above-described embodiments are merely illustrative of the some of the many specific embodiments that represent the principles of the present invention. Clearly, those skilled in the art can readily devise numerous other arrangements without departing from the scope of the present invention.

What is claimed is:

1. A method of automatically focusing an imaging system on an object comprising:
using an image of the object created by the imaging system to determine an optimum focus position.

2. The method of claim 1, wherein the optimum focus position is determined comprising:
computing an edge density of each image of a set of images of the object; and
using a focus position corresponding to an image of the set having a greatest computed edge density as the optimum focus position.

3. The method of claim 1, wherein the optimum focus position is determined comprising:
applying a difference between a first focus position and a second focus position of the imaging system to a third focus position corresponding to the image of the object, such that the third focus position is adjusted to the optimum focus position, wherein the first focus position corresponds to a reference image of a typical object, and wherein the second focus position corresponds to an image of the typical object that closely matches the image of the object.

4. The method of claim 1, wherein using an image automatically accounts for warpage in the object.

5. A method of automatically focusing an imaging system on an object comprising one or both of:
using a first focus position corresponding to an image of the object created by the imaging system that has a greatest edge density as an optimum focus position for the imaging system; and
adjusting a second focus position corresponding to an image of the object by a difference between focus positions for a reference image of a typical object and an image of the typical object that closely matches the image of the object, the typical object representing a class of objects, the object being a member of the class, the imaging system creating the reference image and the closely matched image of the typical object.

6. The method of claim 5, wherein using a first focus position comprises:
creating a set of images of the object at a plurality of different first focus positions using the imaging system, wherein each image in the set is created at a different one of the plurality of first focus positions, such that each image has an associated first focus position; and
computing a density of edges for each image in the set.

7. The method of claim 5, wherein adjusting a second focus position comprises:
creating a set of images of the typical object using the imaging system, each image in the set being created at a different one of a plurality of focus positions;
selecting the reference image from the set of images for the typical object, the reference image having a reference focus position;
creating an image of the object at the second focus position using the imaging system;
comparing the image of the object to images in the set of images of the typical object to find a closest matching image, the closest matching image from the set having a comparison focus position; and
determining a change in the second focus position from the difference between the reference focus position and the comparison focus position, the change being applied to the second focus position, the applied change providing the optimum focus position for the imaging system to image the object.

8. The method of claim 7, wherein the reference image is selected comprising:
computing a density of edges for each image in the set; and
choosing the image from the set having the greatest computed edge density as the reference image.

9. The method of claim 5, wherein using a first focus position and adjusting a second focus position each automatically account for warpage of the object and the typical object.

10. A method of determining an optimum focus position of an imaging system comprising:
creating a set of images of an object at a plurality of different focus positions using the imaging system, wherein each image in the set is created at a different one of the plurality of focus positions, such that each image has an associated focus position;
computing a density of edges for each image in the set; and
determining the optimum focus position for the imaging system, the optimum focus position being the focus position associated with the image having a greatest computed edge density.

11. The method of claim 10, wherein the computed edge density is a relative measure of edges in each of the images.

12. The method of claim 10, wherein the edge density is computed using an edge density metric employing one of any gradient-based and any non-gradient-based edge detection and image processing methods

13. The method of claim 12, wherein a smoothing filter is applied to the image prior to calculating gradients for the gradient-based edge detection.

14. The method of claim 10, wherein the object is representative of a class of objects being imaged, the determined optimum focus position being a reference focus position for the representative object, and wherein the method further comprises:
creating an image of another object at an arbitrary focus position using the imaging system, the other object being a member of the class of objects;
comparing the image of the other object to images in the set of images of the representative object to find a closest matching image, the closest matching image from the set having an associated comparison focus position; and
determining a difference between the reference focus position and the comparison focus position and applying the difference to the arbitrary focus position to provide the optimum focus position for imaging the other object with the imaging system.

15. A method of determining a change in focus position of an imaging system comprising:
creating a set of images of a first object using the imaging system, each image in the set being created at a different one of a plurality of focus positions, such that each image has an associated focus position, the first object being representative of a class of objects;
selecting a reference image from the set of images of the first object, the selected reference image having an associated first focus position;
creating an image of a second object at a second focus position using the imaging system, the second object being a member of the class of objects;
comparing the image of the second object to images in the set of images of the first object to find a closest matching image, the closest matching image from the set having an associated third focus position; and
determining a change in the second focus position to provide an optimum focus position for imaging the second object with the imaging system.

16. The method of claim 15, wherein the change is determined comprising:
determining a difference between the associated first focus position and the associated third focus position; and
adjusting the second focus position by the determined difference, the adjusted second focus position being the optimum focus position.

17. The method of claim 15, wherein the reference image is selected automatically comprising:
computing a density of edges for each image in the set; and
choosing the image from the set having a greatest computed edge density as the reference image.

18. The method of claim 15, wherein the reference image is selected manually by an operator.

19. The method of claim 15, wherein comparing comprises using one or more of a sum of an absolute value of a difference between pixels, a sum of a square of the difference between pixels, and a cross correlation.

20. The method of claim 19, wherein comparing using the cross correlation comprises filtering the image prior to computing a correlation.

21. An imaging system having automatic focusing comprising:
an imaging subsystem that images an object;
a memory;
a computer program stored in the memory; and
a controller that executes the computer program and controls the imaging subsystem, wherein the computer program comprises instructions that, when executed by the controller, implement using an image of the object created by the imaging system to determine an optimum focus position.

22. The imaging system of claim 21, wherein the instructions that implement using the object image to determine the optimum focus position comprises one or both of:
using a first focus position corresponding to an image of the object created by the imaging system that has a greatest edge density as an optimum focus position for the imaging system; and
adjusting a second focus position corresponding to an image of the object by a difference between focus positions for a reference image of a typical object and an image of the typical object that closely matches the image of the object, the typical object representing a class of objects, the object being a member of the class, the imaging system creating the reference image and the closely matched image of the typical object.

23. The imaging system of claim 21, wherein the instructions that implement using the object image to determine the optimum focus position comprise computing an edge density of each image of a set of images of the object; and using a focus position corresponding to an image of the set having a greatest computed edge density as the optimum focus position.

24. The imaging system of claim 21, wherein the instructions that implement using the object image to determine the optimum focus position comprise applying a difference between a first focus position and a second focus position of the imaging system to a third focus position corresponding to the image of the object, such that the third focus position is adjusted to the optimum focus position, wherein the first focus position corresponds to a reference image of a typical object, the second focus position corresponding to an image of the typical object that closely matches the image of the object, the typical object representing a class of objects, the object being imaged being a member of the class, the imaging system creating the reference image and the closely matched image of the typical object.

25. The imaging system of claim 21 being an X-ray laminography system.

26. An imaging system with automatic focusing that images an object, the system having an imaging subsystem; a memory; and a controller that controls the imaging subsystem, the system comprising:
a computer program executed by one or both of the controller or an external processor, the computer program comprising instructions that, when executed, implement one or both of edge detection and image comparison of an image of the object created by the imaging system to determine an optimum focus position for imaging the object.

27. The imaging system of claim 26, wherein the instructions of the computer program implement the edge detection of an image, the edge detection comprising computing an edge density of each image of a set of images of the object; and using a focus position corresponding to an image of the set having a greatest computed edge density as the optimum focus position.

28. The imaging system of claim 26, wherein the instructions of the computer program implement the image comparison of an image, the image comparison comprising adjusting a first focus position used to create the image of the object by a difference between a second focus position corresponding to a reference image of a typical object and a third focus position corresponding to an image of the typical object that closely matches the image of the object, the typical object representing a class of objects, the object being imaged being a member of the class, the imaging system further creating the reference image and the closely matched image of the typical object.

29. The imaging system of claim 27, wherein the instructions further implement the image comparison, the image comparison comprising creating an image of another object at an arbitrary focus position using the imaging system, the object being representative of a class of objects, the other object being a member of the class of objects; comparing the image of the other object to images in the set of images of the representative object to find a closest matching image, the closest matching image from the set having an associated comparison focus position; determining a difference between the optimum focus position and the comparison focus position; and applying the difference to the arbitrary focus position to provide a focus position that is optimum for imaging the other object with the imaging system.

30. The imaging system of claim 26, further comprising an inspection subsystem that provides object inspection.
